(19) United States
(12) Patent Application Publication
(10) Pub. No.: US 2021/0406828 A1
(43) Pub. Date: Dec. 30, 2021

(54) VEHICLE REPAIR ESTIMATING TOOL WITH NEAR-REAL-TIME COMPLIANCE

(71) Applicant: Mitchell International, Inc., San Diego, CA (US)

(72) Inventors: Niv Genchel, San Diego, CA (US); Ravi Kiran Nemani, Carlsbad, CA (US)

(21) Appl. No.: 16/911,317

(22) Filed: Jun. 24, 2020

(51) Int. Cl. G06Q 10/10; G06Q 10/00; G06Q 30/00; G06Q 40/08; G06N 20/00

(52) U.S. Cl. CPC G06Q 10/10; G06Q 10/20; G06N 20/00; G06Q 40/08; G06Q 30/018

(57) ABSTRACT

A vehicle repair estimating tool with near-real-time compliance is provided, In general, one aspect disclosed features a method comprising: providing a near-real-time view of a repair estimate record to a client device, the repair estimate record having one or more fields, receiving, from the client device, a data entry input to be applied to one of the fields of the repair estimate record, selecting, in near real time, one or more compliance rules related to the one of the fields responsive to receiving the data entry input, determining, in near real time, whether the data entry input is valid based on the selected one or more compliance rules, and when the data entry input is determined not to be valid, notifying the client device, in near real time, that the data entry input is not valid for the one of the fields.

### DESCRIPTION OF RELATED ART

The disclosed technology relates generally to systems for estimating vehicle repairs, and more particularly, some embodiments relate to systems and methods for implementing the same.

### SUMMARY

In general, one aspect disclosed features a system, comprising: a hardware processor; and a non-transitory machine-readable storage medium encoded with instructions executable by the hardware processor to perform a method comprising: providing a near-real-time view of a repair estimate record to a client device, the repair estimate record having one or more fields, receiving, from the client device, a data entry input to be applied to one of the fields of the repair estimate record, selecting, in near real time, one or more compliance rules related to the one of the fields responsive to receiving the data entry input, determining, in near real time, whether the data entry input is valid based on the selected one or more compliance rules, and when the data entry input is determined not to be valid, notifying the client device, in near real time, that the data entry input is not valid for the one of the fields.

Embodiments of the system may include one or more of the following features. In some embodiments, the method further comprises: when the data entry input is determined not to be valid, preventing the client device from receiving data entry inputs for other fields of the repair estimate record until a valid data entry input for the one of the fields is received. In some embodiments, the method further comprises: when the data entry input is determined to be valid, entering the data entry input into the one of the fields. In some embodiments, the method further comprises: generating the compliance rules, comprising: training a machine learning model by applying identities of the fields, and valid values for each of the fields, as inputs to the machine learning model; wherein the machine learning model provides the compliance rules as outputs responsive to the inputs. In some embodiments, selecting the one or more compliance rules related to the one of the fields comprises: applying an identity of the one of the fields as an input to a machine learning model being trained using identities of the fields and allowed values for the fields; wherein the machine learning model provides the one or more compliance rules as an output responsive to applying the identity of the one of the fields as an input. In some embodiments, notifying the client device that the data entry input is not valid for the one of the fields comprises: modifying the view of the repair estimate record to indicate the data entry input is not valid; and providing the modified view to the client device. In some embodiments, notifying the client device that the data entry input is not valid for the one of the fields further comprises: further modifying the view of the repair estimate record to indicate valid data entry inputs; and providing the modified view to the client device.

In general, one aspect disclosed features a non-transitory machine-readable storage medium encoded with instructions executable by a hardware processor of a computing component, the machine-readable storage medium comprising instructions to cause the hardware processor to perform a method comprising: providing a near-real-time view of a repair estimate record to a client device, the repair estimate record having one or more fields; receiving, from the client device, a data entry input to be applied to one of the fields of the repair estimate record; selecting, in near real time, one or more compliance rules related to the one of the fields responsive to receiving the data entry input; determining, in near real time, whether the data entry input is valid based on the selected one or more compliance rules; and when the data entry input is determined not to be valid, notifying the client device, in near real time, that the data entry input is not valid for the one of the fields.

Embodiments of the non-transitory machine-readable storage medium may include one or more of the following features. In some embodiments, the method further comprises: when the data entry input is determined not to be valid, preventing the client device from receiving data entry inputs for other fields of the repair estimate record until a valid data entry input for the one of the fields is received. In some embodiments, the method further comprises: when the data entry input is determined to be valid, entering the data entry input into the one of the fields. In some embodiments, the method further comprises: generating the compliance rules, comprising: training a machine learning model by applying identities of the fields, and valid values for each of the fields, as inputs to the machine learning model; wherein the machine learning model provides the compliance rules as outputs responsive to the inputs. In some embodiments, selecting the one or more compliance rules related to the one of the fields comprises: applying an identity of the one of the fields as an input to a machine learning model being trained using identities of the fields and allowed values for the fields; wherein the machine learning model provides the one or more compliance rules as an output responsive to applying the identity of the one of the fields as an input. In some embodiments, notifying the client device that the data entry input is not valid for the one of the fields comprises: modifying the view of the repair estimate record to indicate the data entry input is not valid; and providing the modified view to the client device. In some embodiments, notifying the client device that the data entry input is not valid for the one of the fields further comprises: further modifying the view of the repair estimate record to indicate valid data entry inputs; and providing the modified view to the client device.

In general, one aspect disclosed features a near-real-time method implemented by a server computer, the method comprising: providing a near-real-time view of a repair estimate record to a client device, the repair estimate record having one or more fields; receiving, from the client device, a data entry input to be applied to one of the fields of the repair estimate record; selecting, in near real time, one or more compliance rules related to the one of the fields responsive to receiving the data entry input; determining, in near real time, whether the data entry input is valid based on the selected one or more compliance rules; and when the data entry input is determined not to be valid, notifying the client device, in near real time, that the data entry input is not valid for the one of the fields.

Embodiments of the method may include one or more of the following features. Some embodiments comprise, when the data entry input is determined not to be valid, preventing the client device from receiving data entry inputs for other fields of the repair estimate record until a valid data entry input for the one of the fields is received. Some embodiments comprise, when the data entry input is determined to be valid, entering the data entry input into the one of the fields. Some embodiments comprise generating the compliance rules, comprising: training a machine learning model by applying identities of the fields, and valid values for each of the fields, as inputs to the machine learning model; wherein the machine learning model provides the compliance rules as outputs responsive to the inputs. In some embodiments, selecting the one or more compliance rules related to the one of the fields comprises: applying an identity of the one of the fields as an input to a machine learning model being trained using identities of the fields and allowed values for the fields; wherein the machine learning model provides the one or more compliance rules as an output responsive to applying the identity of the one of the fields as an input. In some embodiments, notifying the client device that the data entry input is not valid for the one of the fields comprises: modifying the view of the repair estimate record to indicate the data entry input is not valid; and providing the modified view to the client device.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a near-real-time collaborative vehicle repair estimating system according to some embodiments of the disclosed technology.

FIG. 2 illustrates a process for a vehicle repair cycle including near-real-time collaborative repair estimation according to some embodiments of the disclosed technology.

FIG. 3 illustrates a process for vehicle repair estimating with near-real-time compliance according to some embodiments of the disclosed technology.

FIG. 4 illustrates a process for using a machine learning model to generate compliance rules according to some embodiments of the disclosed technology.

FIG. 5 illustrates a process for using machine learning model to select compliance rules related to the field for which a data entry input has been received.

FIG. 6 illustrates a job overview generated by the near-real-time tool according to some embodiments of the disclosed technology.

FIG. 7 illustrates a repair estimate view generated by the near-real-time tool according to some embodiments of the disclosed technology.

FIG. 8 illustrates a repair estimate view generated by the near-real-time tool in response to attempted change according to some embodiments of the disclosed technology.

FIG. 9 is an example computing component that may be used to implement various features of embodiments described in the present disclosure.

The figures are not exhaustive and do not limit the present disclosure to the precise form disclosed.

### DETAILED DESCRIPTION

With the advent of high-power, cost effective computing systems came the increased automation of numerous facets of our contemporary society. In the insurance and other casualty and loss industries, for example, computerized claims estimating, processing, tracking and payment systems have long been in use to streamline the process and to expedite claims handling and closure.

Despite these advances, due to its collaborative nature, the generation of claims estimates remains a long and tedious process, requiring input and review from multiple parties involved in the estimating process. A conventional estimating process begins with one party, for example an estimator in a repair shop, generating an estimate. The estimate is then forwarded to a second party, for example a claims adjuster for an insurer, for review and possible modification. Any modifications by one party must be forwarded to another party for review and approval. The generation of a final estimate may involve ending number of these review, modification, forwarding, and approval cycles, which may be applied by two or more lines of the estimate. For these reasons, conventional estimating processes consume a significant portion of the repair cycle.

A common reason for rejecting an estimate is that the data entered into a field is not in compliance with one or more compliance rules. For example, a labor rate entered into the estimate may exceed a maximum labor rate set by a compliance rule. As another example, a quantity entered for a particular part may exceed a maximum quantity of the parts allowed by another compliance rule. Such compliance rules may be based on requirements sent by insurers, vehicle manufacturers, original equipment manufacturers, and the like, and combinations thereof.

Embodiments of the disclosed technology provide a vehicle repair estimating tool with near-real-time compliance which overcomes these difficulties. The tool provides near-real-time feedback for each data entry for a repair estimate record. As used herein, the term “record” may refer to an electronic document, or the like. For example, when a data entry input for a particular field in a repair estimate record is received from a user, the tool selects one or more compliance rules related to that field, and determines selected compliance rule(s). When the data entry input is determined to be valid, the tool enters the data entry input into the field and the repair estimate record. But when the data entry input is determined not to be valid, the tool notifies the user. For example, the tool may modify the view of the record provided to the user to highlight the field to indicate that the data entry input is not valid. The tool may also provide a notice that indicates validate data entry inputs for the field. In some embodiments, the tool may lock out other fields in the estimate until valid data entry input is provided for the current field. The steps are performed in near-real-time.

This near-real-time operation provides several advantages. First, it serves to help the user generate a repair estimate that is more accurate, and less likely to be rejected by other users. And because the repair estimate is less likely to be rejected, the number of review cycles for the estimate is reduced. On the user side, this reduction in the number of new cycles reduces the amount of labor involved in creating a valid repair estimate. On the processing side, this reduction in the number of cycles serves to reduce the processing load for the server(s) hosting the tool.

Rather than being implemented as multiple instances deployed at multiple customer sites, the tool may be implemented in a cloud deployment such that multiple users may access an estimate concurrently. In some embodiments, a change made to the estimate by one user is immediately made available to other users. In some embodiments, multiple users may change different parts of the estimate concurrently. In some embodiments, a proposed change may be shown in a highlighted manner to draw the attention of other users to the proposed change. These and other embodiments and features are described below.

In this description, various embodiments are disclosed for generating estimates for vehicle repairs. However, embodiments of the disclosed technology apply to the generation of any type of estimate that requires the collaboration of multiple parties. For example, embodiments may apply to generating estimates for medical procedures, and the like. These and other applications will be apparent to one skilled in the relevant art after reading this description.

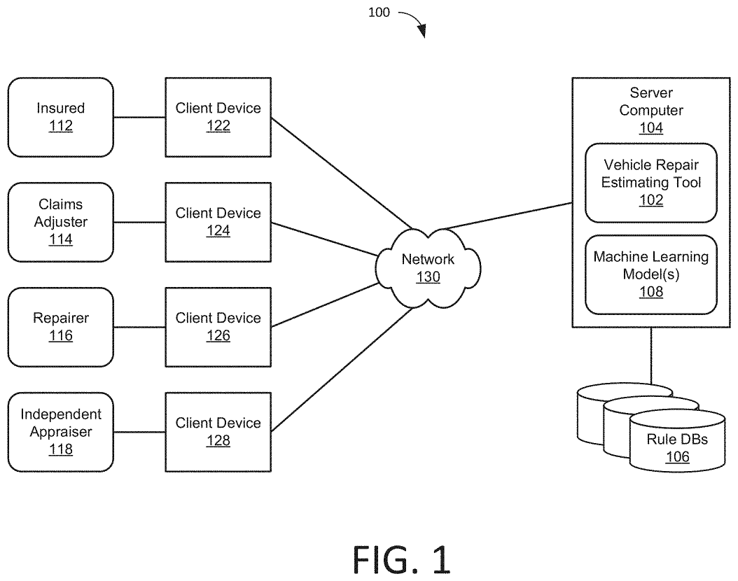

FIG. 1 illustrates a near-real-time collaborative vehicle repair estimating system 100 according to some embodiments of the disclosed technology. Referring to FIG. 1, the system 100 includes a vehicle repair estimating tool with near-real-time compliance 102, which may be implemented as one or more software packages executing on one or more server computers 104. The system may include one or more databases 106, which may store completed estimates, estimates in process, data regarding parts, part costs, labor, labor costs, and the like. The near-real-time tool 102 may access the databases 106 over a network 130 such as the Internet, via direct links, and the like. In some embodiments, the system may employ one or more machine learning models 108, which may execute on the server computer 104.

Multiple users may be involved in the estimating process. For example, users may include the insured 112, a claims adjuster 114, a repairer 116 such as an employee of a repair shop, an independent appraiser 118, and the like. Each user may access the near-real-time tool 102 over the network 130 using a respective client device 122, 124, 126, 128. Each client device may be implemented as a desktop computer, laptop computer, smart phone, and the like.

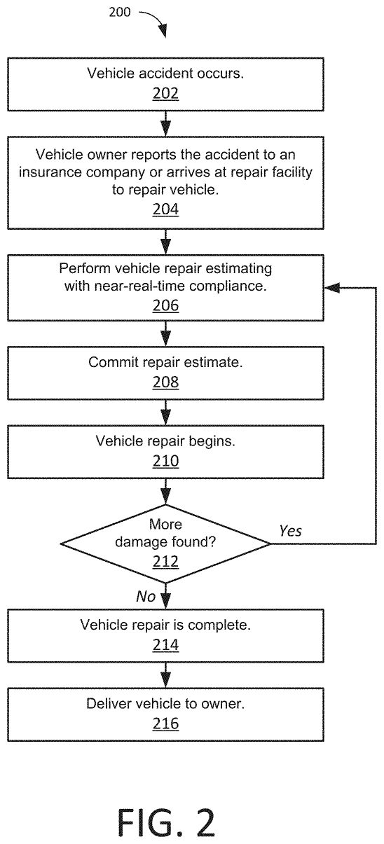

FIG. 2 illustrates a process 200 for a vehicle repair cycle including near-real-time collaborative repair estimation according to some embodiments of the disclosed technology. Referring to FIG. 2, the process 200 may begin with a vehicle accident, at 202, and may continue with the vehicle owner reporting the accident to an insurance company, or arriving at a repair facility to repair the vehicle, at 204.

Next, the process may include performing vehicle repair estimating with near-real-time compliance, at 206, as discussed in detail in this description. This near-real-time process may involve the generation of a repair estimate record, followed by multiple rounds of revision and review. For example, a staff appraiser of an insurance company may visit the damaged vehicle to take photos and assess the damage. Based on this assessment, the appraiser may generate a repair estimate record.

The vehicle may be taken to an auto repair shop, where an employee may further assess the damage, and may revise the estimate by using a computer device to revise the repair estimate record. An insurance staff employee may review the revised record, and accept or reject revisions made by the auto repair shop employee. The auto repair shop employee may accept or reject revisions made by the insurance staff employee. This near-real-time collaboration process may be repeated as many times as needed.

The insurance company may also send an independent appraiser to further assess the damage on the vehicle. The insurance company staff appraiser and the independent appraiser may collaborate in near real time to revise the estimate, for example by making further revisions and by accepting or rejecting those revisions. These are merely examples. Any group of two or more users may collaborate in near real time to revise the repair estimate.

When the users collaborating on the repair estimate agree, one of the users may commit the repair estimate, at 208. After the repair estimate is committed, the repair of the vehicle may begin, at 210. During the repair of the vehicle, more damage may be found, at 212. If more damage is found, the process 200 may return to near real-time collaborative repair estimation, at 206, for example by generating a supplement estimate. When no additional damages are found, 212, the repair of the vehicle may be completed, at 214, and the repaired vehicle may be delivered to the vehicle owner, at 216.

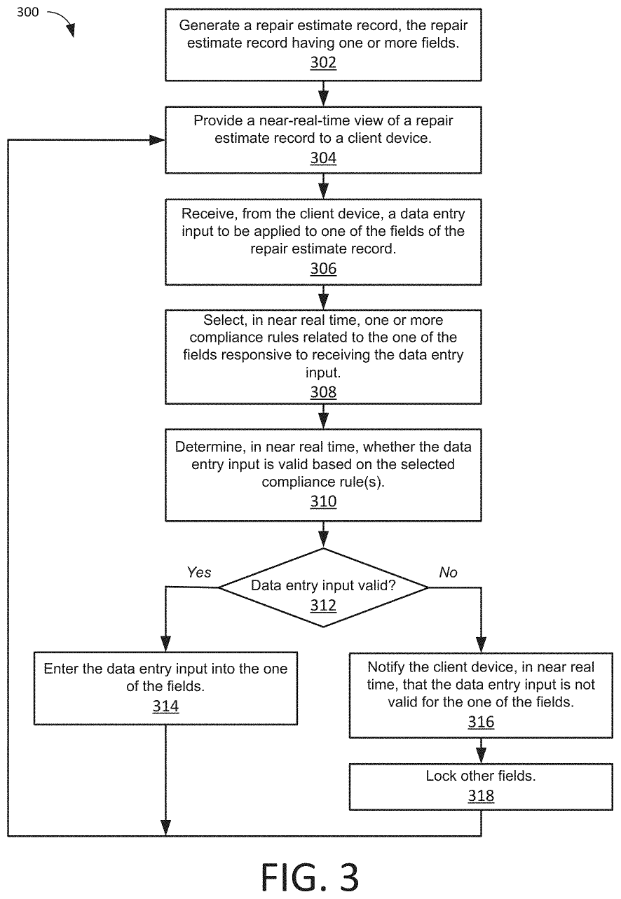

FIG. 3 illustrates a process 300 for vehicle repair estimating with near-real-time compliance according to some embodiments of the disclosed technology. The process 300 may begin with a user generating a repair estimate record using one of the client devices, at 302. For example, the user may be an insurance claims adjuster, and the client device may be the adjuster's smart phone. The user may employ the client device to cause the near-real-time tool 102 to create a new repair estimate record by selecting a particular repair estimate template, and may generate the repair estimate record by adding one or more repair lines to the new repair estimate record. Each repair line may represent a phase of the vehicle repair. For example, one line might represent repair of the vehicle bumper, while another line may represent replacements of a headlamp assembly. Each line of the estimate may have one or more fields requiring data entry inputs from the users.

Responsive to the generation of the estimate record, the collaborative vehicle repair estimating tool 102 may provide a near-real-time view of the repair estimate record to a client device, at 304. In some embodiments, multiple users may view the repair estimate record in near real time. And because the views are near-real-time deals, users may view the repair estimate record while it is being created. For example, when the claims adjuster enters a new line into the estimate, the near-real-time views provided to the client devices may be updated to show that new line.

In some embodiments, the near-real-time views provided to the client devices may be updated more frequently. For example, the near-real-time views may be substantially the same as the view seen by the auto repair shop employee. In these embodiments, the users can see every action performed by the auto repair shop employee.

In addition to viewing the estimate in near real time, users may also revise the estimate in near real time. That is, the user may employ a client device to submit a data entry input to be applied to one of the fields in the repair estimate record. The near-real-time tool 102 may receive the data entry input to the repair estimate record from the client device, at 306. Responsive to receiving the data entry input for the field, the near-real-time tool 102 may select in near real time, one or more compliance rules related to the field, at 308. For example, when the data in the field specifies a quantity of a particular part, the near-real-time tool 102 may select a compliance rule specifying a maximum quantity of the particular part that may be included in estimate. As another example, when the data in the field specifies a labor rate, the near-real-time tool may select a compliance rule specifying a maximum labor rate for the estimate. In some embodiments, machine learning models may be employed to generate the compliance rules, to select one or more compliance rules related to a particular field and the repair line itself or its relation to other repair lines in the estimate or based on repair procedures or any other source of data, or both, as described in detail below.

After selecting the compliance rule(s) related to the field and the repair line, the near-real-time tool 102 may determine, in near real time, whether the data entry input for that field is valid based on compliance rule(s), at 310. When the near-real-time tool 102 determines the data entry input to be valid for the field, at 312, the near-real-time tool may enter the data entry input into that field in the repair estimate record or suggest multiple valid options that can be used and may also default to one of the options, at 314. The process 300 may then continue with providing a near-real-time view of the repair estimate to the client device, where the near-real-time view shows the data entry input as entered into the field.

However, when the near-real-time tool determines the data entry input not to be valid for the field, at 312, the near-real-time tool may notify the client device, in near real time, that the data entry input is not valid for the field, at 316. Continuing the first example above, when the quantity specified by the data entry input for the number of parts exceeds the maximum quantity specified by the related compliance rule, the near-real-time tool 102 determines that data entry input to be invalid. Continuing the second example above, when the data entry input for the labor rate exceeds the maximum labor rate specified by the related compliance rule, the near-real-time tool determines that data entry input to be invalid.

Notifying the client device may include modifying the view of the repair estimate record to indicate that the data entry input is not valid, for example by highlighting the field in the view, and providing the modified due to the client device. But any notification method may be used. In some embodiments, notifying the client device that the data entry input is not valid for the field may include modifying the view of the repair estimate record to indicate valid data entry inputs. Continuing the first example above, the notification may include a message indicating the maximum allowed quantity of parts. Continuing the second example above, the notification may include a message indicating the maximum allowed labor rate. In some examples, the system may allow the user to override the compliance error and use the original value that was provided. In these cases, the system may require the user to enter an explanation, or the system may provide an automatic explanation or suggest multiple explanation options or both before allowing the invalid value to be recorded. Explanation options can be a combination of predefined system options, AI/Machine Learning generated options or predefined user options.

In some embodiments, the near-real-time tool may also lock one or more other fields in the repair estimate record to prevent data entry into those other fields, and 318, and may keep those fields locked until a valid data entry input is received for the field. These embodiments help to ensure that all of the fields in the repair estimate record are populated with valid data.

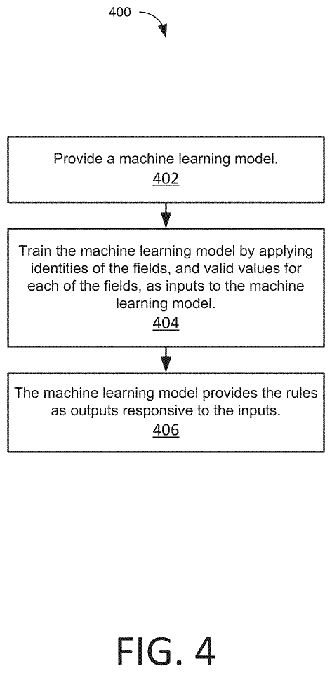

As mentioned above, in some embodiments, some or all of the compliance rules may be generated using a machine learning model. Other artificial intelligence techniques may be used instead of, or in addition to, using a machine learning model. FIG. 4 illustrates a process 400 for using a machine learning model to generate compliance rules according to some embodiments of the disclosed technology. Referring to FIG. 4, the process 400 may include providing a machine learning model, at 402. The machine learning model may be any machine learning model capable of the functions described herein.

The process 400 may include training machine learning model, at 404. For example, the identities of the fields used in the repair estimate records, and valid values for each of those fields, may be provided as inputs to the machine learning model. Training the machine learning model may include supervised learning, unsupervised learning, or combinations thereof. In addition, the machine learning may also be based on textual analysis of original equipment (OE) manuals or any other operating, technical, and repair procedures, as well as image recognition of the vehicle damage based on photos/videos and other type of media.

The process 400 may include the machine learning model providing the compliance rules as outputs, responsive to the provided inputs, at 406. Referring to FIG. 1, the compliance rules may be stored in the database(s) 106.

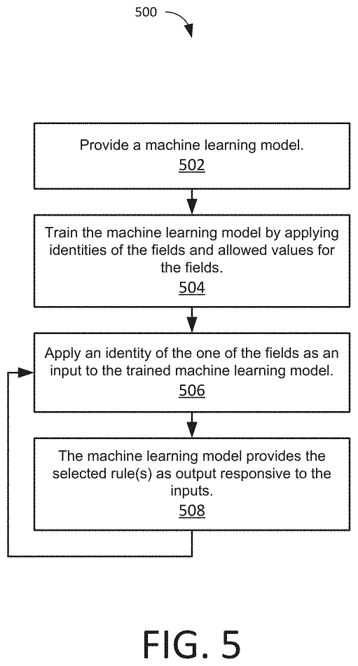

As mentioned above, in some embodiments, a machine learning model may be used, in near real time, to select some or all of the compliance rules related to a field for which a data entry input has been received. Other artificial intelligence techniques may be used instead of, or in addition to, using a machine learning model. FIG. 5 illustrates a process 500 for using machine learning model to select compliance rules related to the field for which a data entry input has been received. Referring to FIG. 5, the process 500 may include providing a machine learning model, at 502. The machine learning model may be any machine learning model capable of the functions described herein.

The process 500 may include training the machine learning model, at 504. For example, the identities of the fields used in the repair estimate records, and allowed values for those fields, may be applied as inputs to machine learning model. Training the machine learning model may include supervised learning, unsupervised learning, or combinations thereof.

After training, the machine learning model may be used in near real time to select or create new compliance rules related to the field for which a data entry input has been received. Upon receiving a data entry input, the near-real-time tool may apply an identity of the field as an input to the trained machine learning model in near real time, at 506. Responsive to this input, the trained machine learning model may provide the selected compliance rule(s) as output, in near real time, at 508. The selected compliance rule output by the trained machine learning model may be used to validate the data entry input, as described above.

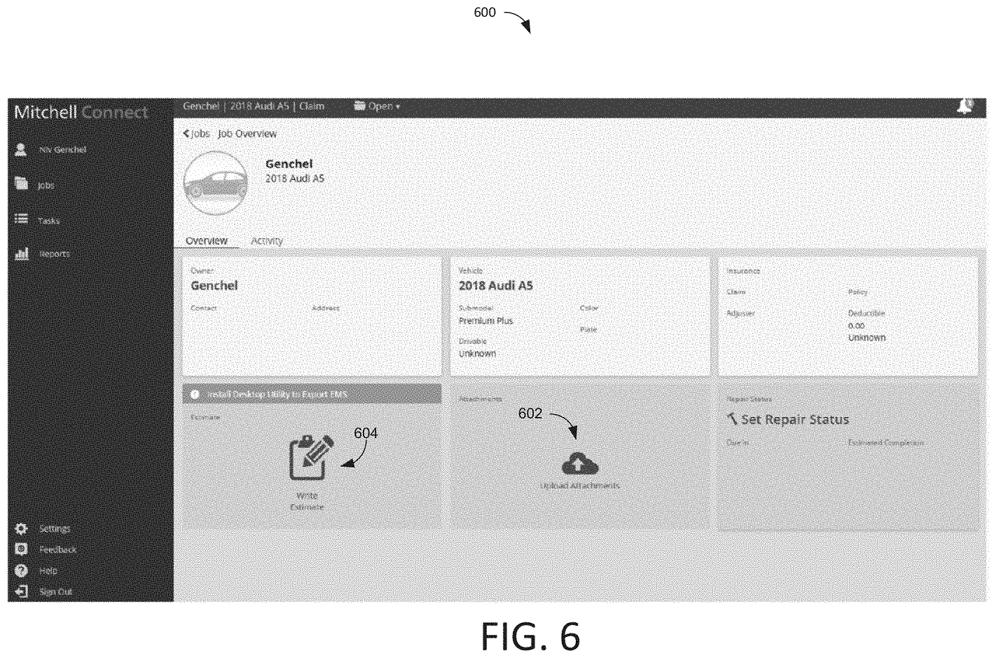

Now several example views provided by the near-real-time tool 102 are illustrated and discussed. FIG. 6 illustrates a job overview 600 generated by the near-real-time tool 102 according to some embodiments of the disclosed technology. Referring to FIG. 6, the job overview 600 provides information describing the vehicle, the vehicle owner, the vehicle owner's insurance policy, the repair status of the vehicle, any attachments associated with the estimate, and the like. The vehicle owner information may include the vehicle owner's name, address, contact information, and the like. The vehicle information may include the year, make, and model of the vehicle, as well as the submodel, color, license plate number, whether the vehicle is drivable, and the like. The insurance information may include the policy number, claim number, deductible amounts, contact information for the claim adjuster, and the like. The repair status information may include when the vehicle is due into the auto repair shop, when the repair is estimated to be complete, and the like. The attachments may include photos, videos, repair instructions, OE procedures of the vehicle, a summary of the owner's insurance policy, and the like. In this example, no attachments have been uploaded. The near-real-time tool 102 allows a user to upload attachments by clicking the “Upload Attachments” button, at 602. The near-real-time tool 102 also allows a user to begin writing an estimate, by clicking the “Write Estimate” button, at 604.

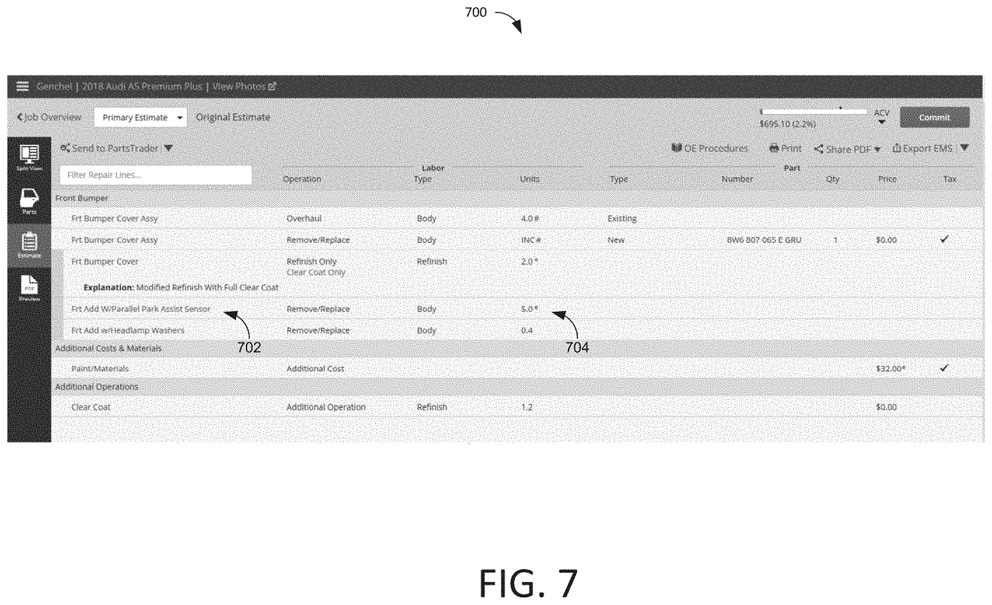

FIG. 7 illustrates a repair estimate view 700 generated by the near-real-time tool 102 according to some embodiments of the disclosed technology. In this view 700, a user has added several lines to the estimate. This example will focus on the line for “Frt Add W/Parallel Park Assist Sensor”, indicated at 702. In this view 700, the number of units shown for line 702 is “5.0”, as shown at 704. In this example, the user attempts to change that number from “5.0” to “20.0”.

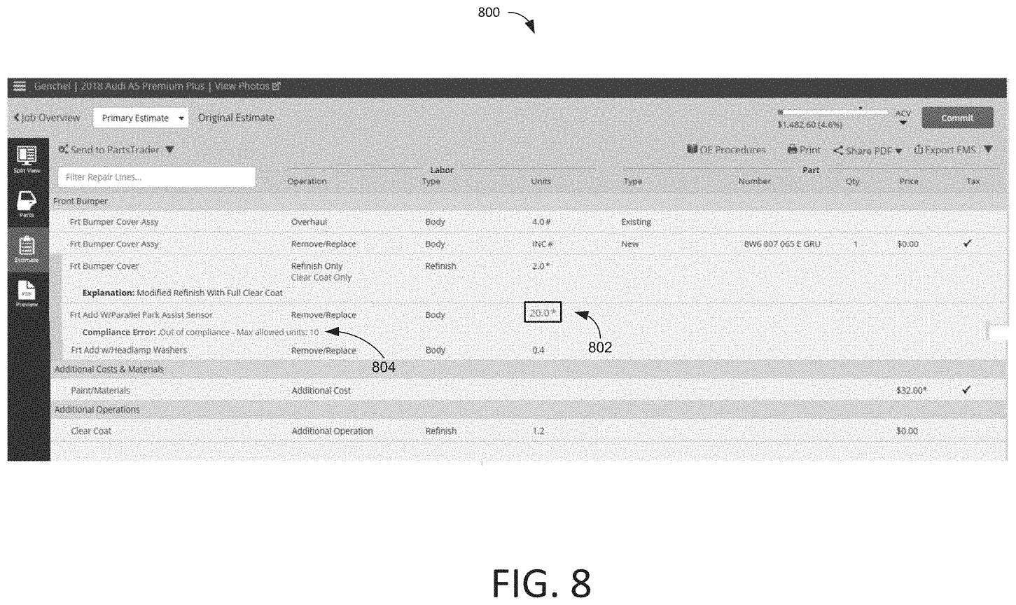

FIG. 8 illustrates a repair estimate view 800 generated by the near-real-time tool 102 in response to attempted change according to some embodiments of the disclosed technology. In this view 800, the near-real-time tool 102 has determined the quantity of units “20.0” entered by the user is not valid for this field, and therefore has modified the view 700 of the repair estimate record accordingly. In particular, the view 800 has highlighted the field with a box, at 802. In addition, the compliance error message has been added to the line to indicate that the maximum allowed units is 10, at 804. At this point, the user may make a different data entry input for the line to bring the data entry input into compliance.

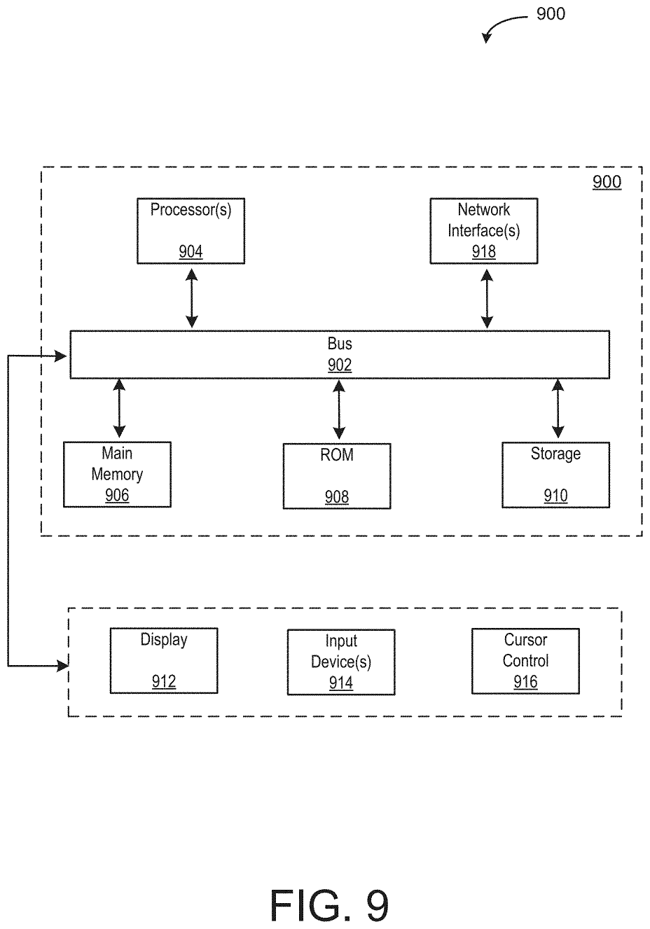

FIG. 9 depicts a block diagram of an example computer system 900 in which embodiments described herein may be implemented. The computer system 900 includes a bus 902 or other communication mechanism for communicating information, one or more hardware processors 904 coupled with bus 902 for processing information. Hardware processor(s) 904 may be, for example, one or more general purpose microprocessors.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

The computer system 900 may be coupled via bus 902 to a display 912, such as a liquid crystal display (LCD) (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. In some embodiments, the same direction information and command selections as cursor control may be implemented via receiving touches on a touch screen without a cursor.

The computing system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

The computer system 900 also includes a communication interface 918 coupled to bus 902. Network interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or a WAN component to communicate with a WAN). Wireless links may also be implemented. In any such implementation, network interface 918 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 918, which carry the digital data to and from computer system 900, are example forms of transmission media.

The computer system 900 can send messages and receive data, including program code, through the network(s), network link and communication interface 918. In the Internet example, a server might transmit a requested code for an application program through the Internet, the ISP, the local network and the communication interface 918.

The received code may be executed by processor 904 as it is received, and/or stored in storage device 910, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system XYZ00.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
a hardware processor; and
a non-transitory machine-readable storage medium encoded with instructions executable by the hardware processor to perform a method comprising:
providing a near-real-time view of a repair estimate record to a client device, the repair estimate record having one or more fields,
receiving, from the client device, a data entry input to be applied to one of the fields of the repair estimate record,
selecting, in near real time, one or more compliance rules related to the one of the fields responsive to receiving the data entry input,
determining, in near real time, whether the data entry input is valid based on the selected one or more compliance rules, and
when the data entry input is determined not to be valid, notifying the client device, in near real time, that the data entry input is not valid for the one of the fields.

2. The system of claim 1, the method further comprising:
when the data entry input is determined not to be valid, preventing the client device from receiving data entry inputs for other fields of the repair estimate record until a valid data entry input for the one of the fields is received.

3. The system of claim 1, the method further comprising:
when the data entry input is determined to be valid, entering the data entry input into the one of the fields.

4. The system of claim 1, the method further comprising:
generating the compliance rules, comprising:
training a machine learning model by applying identities of the fields, and valid values for each of the fields, as inputs to the machine learning model;
wherein the machine learning model provides the compliance rules as outputs responsive to the inputs.

5. The system of claim 1, wherein selecting the one or more compliance rules related to the one of the fields comprises:
applying an identity of the one of the fields as an input to a machine learning model being trained using identities of the fields and allowed values for the fields;
wherein the machine learning model provides the one or more compliance rules as an output responsive to applying the identity of the one of the fields as an input.

6. The system of claim 1, wherein notifying the client device that the data entry input is not valid for the one of the fields comprises:
modifying the view of the repair estimate record to indicate the data entry input is not valid; and
providing the modified view to the client device.

7. The system of claim 6, wherein notifying the client device that the data entry input is not valid for the one of the fields further comprises:
further modifying the view of the repair estimate record to indicate valid data entry inputs; and
providing the modified view to the client device.

8. A non-transitory machine-readable storage medium encoded with instructions executable by a hardware processor of a computing component, the machine-readable storage medium comprising instructions to cause the hardware processor to perform a method comprising:
providing a near-real-time view of a repair estimate record to a client device, the repair estimate record having one or more fields;
receiving, from the client device, a data entry input to be applied to one of the fields of the repair estimate record;
selecting, in near real time, one or more compliance rules related to the one of the fields responsive to receiving the data entry input;
determining, in near real time, whether the data entry input is valid based on the selected one or more compliance rules; and
when the data entry input is determined not to be valid, notifying the client device, in near real time, that the data entry input is not valid for the one of the fields.

9. The non-transitory machine-readable storage medium of claim 8, the method further comprising:
when the data entry input is determined not to be valid, preventing the client device from receiving data entry inputs for other fields of the repair estimate record until a valid data entry input for the one of the fields is received.

10. The non-transitory machine-readable storage medium of claim 8, the method further comprising:
when the data entry input is determined to be valid, entering the data entry input into the one of the fields.

11. The non-transitory machine-readable storage medium of claim 8, the method further comprising:
generating the compliance rules, comprising:
training a machine learning model by applying identities of the fields, and valid values for each of the fields, as inputs to the machine learning model;
wherein the machine learning model provides the compliance rules as outputs responsive to the inputs.

12. The non-transitory machine-readable storage medium of claim 8, wherein selecting the one or more compliance rules related to the one of the fields comprises:
applying an identity of the one of the fields as an input to a machine learning model being trained using identities of the fields and allowed values for the fields;
wherein the machine learning model provides the one or more compliance rules as an output responsive to applying the identity of the one of the fields as an input.

13. The non-transitory machine-readable storage medium of claim 8, wherein notifying the client device that the data entry input is not valid for the one of the fields comprises:
modifying the view of the repair estimate record to indicate the data entry input is not valid; and
providing the modified view to the client device.

14. The non-transitory machine-readable storage medium of claim 13, wherein notifying the client device that the data entry input is not valid for the one of the fields further comprises:
further modifying the view of the repair estimate record to indicate valid data entry inputs; and
providing the modified view to the client device.

15. A near-real-time method implemented by a server computer, the method comprising:
providing a near-real-time view of a repair estimate record to a client device, the repair estimate record having one or more fields;
receiving, from the client device, a data entry input to be applied to one of the fields of the repair estimate record;
selecting, in near real time, one or more compliance rules related to the one of the fields responsive to receiving the data entry input;
determining, in near real time, whether the data entry input is valid based on the selected one or more compliance rules; and
when the data entry input is determined not to be valid, notifying the client device, in near real time, that the data entry input is not valid for the one of the fields.

16. The near-real-time method of claim 15, further comprising:
when the data entry input is determined not to be valid, preventing the client device from receiving data entry inputs for other fields of the repair estimate record until a valid data entry input for the one of the fields is received.

17. The near-real-time method of claim 15, further comprising:
when the data entry input is determined to be valid, entering the data entry input into the one of the fields.

18. The near-real-time method of claim 15, further comprising:
generating the compliance rules, comprising:
training a machine learning model by applying identities of the fields, and valid values for each of the fields, as inputs to the machine learning model;
wherein the machine learning model provides the compliance rules as outputs responsive to the inputs.

19. The near-real-time method of claim 15, wherein selecting the one or more compliance rules related to the one of the fields comprises:
applying an identity of the one of the fields as an input to a machine learning model being trained using identities of the fields and allowed values for the fields;
wherein the machine learning model provides the one or more compliance rules as an output responsive to applying the identity of the one of the fields as an input.

20. The near-real-time method of claim 15, wherein notifying the client device that the data entry input is not valid for the one of the fields comprises:
modifying the view of the repair estimate record to indicate the data entry input is not valid; and
providing the modified view to the client device.
